(19) United States
(12) Patent Application Publication
(10) Pub. No.: US 2009/0111508 A1
(43) Pub. Date: Apr. 30, 2009

(54) HANDHELD COMMUNICATION DEVICE HAVING DUAL OPERATING MODES

(76) Inventors: Wang-Hung Yeh, Taoyuan City (TW); Hung-Ming Chen, Tainan City (TW)

Correspondence Address: HDLS Patent & Trademark Services, P.O. BOX 220746, CHANTILLY, VA, 20153-0746, US

(21) Appl. No.: 11/926,306

(22) Filed: Oct. 29, 2007

(51) Int. Cl. H04M 1/00

(52) U.S. Cl. 455/552.1; 455/566; 455/575.8

(57) ABSTRACT

A handheld communication device having dual operating modes includes a casing, a display and a keyboard. The casing is formed with an accommodating trough. One side of the accommodating trough is provided with a first connecting port. Further, the casing is provided thereon with a receiver. The display is sealed to cover on the accommodating trough and is displaceable with respect to the casing. The keyboard is detachably received in the accommodating trough. One side of the keyboard is provided with a second connecting port for insertion to correspond to the first connecting port. The keyboard is provided with an emitter for transmitting wireless signals to the receiver and a battery module for providing the necessary power of the emitter. Via the mutual insertion and disconnection between the second connecting port and the first connecting port, wired and wireless operating modes can be switched.

### BACKGROUND OF THE INVENTION

1. Field of the Invention

The present invention relates to a communication device, and in particular to a handheld communication device.

2. Description of Prior Art

The development of the communication industry promotes the handheld communication device continuously. The handheld communication device has developed from the most original stage of simple handheld mobile phone to the modern smart mobile phone having several functions such as a digital camera, MP3 player, radio and GPS navigation or a communication device such as a personal digital assistant, which has brought about great convenience in our daily life and work.

The existing handheld communication device is equipped with a standard keyboard for typing, in which the keyboard is provided on the device directly. Such design merely allows the user to operate with single hand, or allows the user to key in with both hands supporting and pressing the keyboard. As a result, the user keeps the same posture during operation. After operating for a long time, since the head and hands of the user are held in a fixed angular position, the neck and hands fatigue and pain easily. Therefore, it is necessary to improve the conventional handheld communication device.

### SUMMARY OF THE INVENTION

The present invention is to provide a handheld communication device having dual operating modes. Via the mutual insertion and disconnection between a second connecting port and a first connecting port, wired and wireless operating modes can be switched.

The present invention is to provide a handheld communication device having dual operating modes, which includes a casing, a display and a keyboard. The casing is formed with an accommodating trough. One side of the accommodating trough is provided with a first connecting port. Further, the casing is provided thereon with a receiver. The display is sealed to cover on the accommodating trough and is displaceable with respect to the casing. The keyboard is detachably received in the accommodating trough. One side of the keyboard is provided with a second connecting port for insertion to correspond to the first connecting port. The keyboard is provided with an emitter for transmitting wireless signals to a receiver and a battery module for providing the necessary power of the emitter.

The present invention is to provide a handheld communication device having dual operating modes. With the detachable design of the casing and the keyboard, the communication device can be adjusted according to the demands of the user, thereby improving the usability.

### BRIEF DESCRIPTION OF THE DRAWINGS

FIG. 1 is an exploded perspective view of the present invention;

FIG. 2 is an assembled perspective view of the present invention;

FIG. 3 is a schematic view showing the operating state of a wired communication of the present invention;

FIG. 4 is a schematic view (I) showing the operating state of a wireless communication of the present invention; and

FIG. 5 is a schematic view (II) showing the operating state of a wireless communication of the present invention.

### DETAILED DESCRIPTION OF THE INVENTION

The detailed description and the technical contents of the present invention will be explained with reference to the accompanying drawings. However, the drawings are illustrative only but not used to limit the present invention.

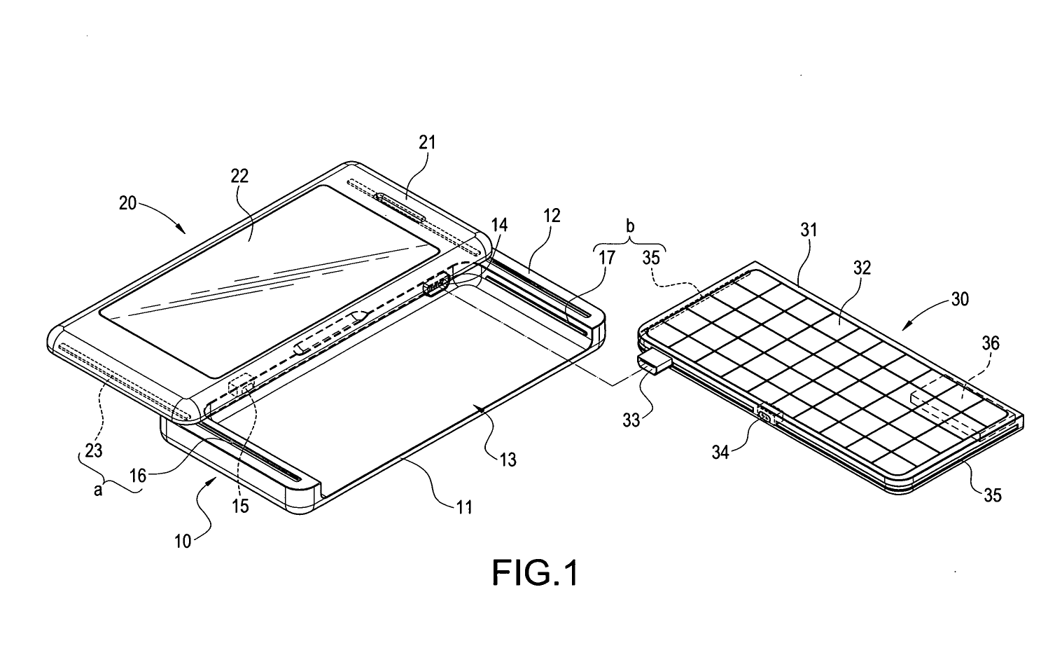

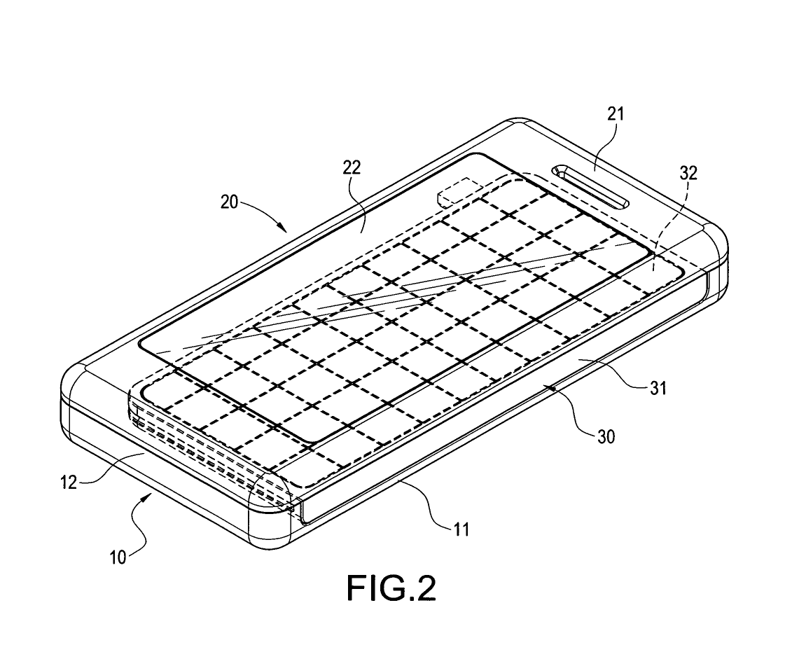

FIG. 1 and FIG. 2 are an exploded perspective view and an assembled view of the present invention. The present invention provides a handheld communication device having dual operating modes, which includes a casing 10, a display 20 and a keyboard 30.

The casing 10 comprises a rectangular base 11 and a flat-bottomed U-lettered surrounding plate 12 extending upwardly from the periphery of the base 11. An accommodating trough 13 is formed in the interior of the base 11 and the surrounding plate 12. One side of the closed end of the surrounding plate 12 is fixedly connected with a first connecting port 14, and the other end of the first connecting port 14 is electrically connected to a circuit within the casing 10 via leads (not shown). A receiver 15 is mounted in the casing 10. Further, the top surfaces of two side arms of the surrounding plate 12 are formed respectively with two guiding troughs 16 parallel to each other, while the inside surfaces of the two side arms of the surrounding plate 12 are formed respectively with two guiding rails 17 parallel to each other.

The display is sealed to cover on the accommodating trough 13 of the casing 10, and comprises a frame plate 21 corresponding to the outer periphery of the casing 10 and a screen 22 mounted on the top of the frame plate 21. The elements or devices within the frame plate 21 are electrically connected to the casing 10 via leads (not shown). Further, the bottom surface of the frame plate 21 is provided with sliding rails 23 at positions corresponding to those of the guiding troughs 16 of the surrounding plate 12, so that the sliding rails and the guiding troughs 16 can be slidably mated with each other to constitute a first sliding means a of the present invention.

The keyboard 30 comprises a base plate 31 and a plurality of press keys 32 provided on the base plate 31. The base plate 31 can be accommodated in the accommodating trough 13 of the casing 10, and is provided with a second connecting port at a position corresponding to that of the first connecting port 14. The other end of the second connecting port 33 is connected with the circuit within the casing via leads. With the mutual insertion between the first and second connecting ports 14, 33, the signal communication between the keyboard 30 and the casing 10 can be achieved in a wired manner. Further, the center of the front of the base plate 31 is fixedly connected with an emitter 34. The emitter 34 is used to transmit infrared or bluetooth wireless signals to a receiver of the casing 10. With the transmitting and receiving operations between the emitter 34 and the receiver 15, the signal transmission can be still achieved by switching from the wired manner to a wireless manner via a switch controller (not shown) provided in the casing 10, even when the first and second connecting ports 14, 33 are not connected to each other. Further, both sides of the base plate 31 are provided with sliding troughs 35 at positions corresponding to those of the guiding rails 17 of the surrounding plate 12, so that the sliding troughs and the guiding rails can be slidably mated with each other to constitute a second sliding means b of the present invention. In addition, the keyboard 30 can communicate the signals with the casing 10 via a wired or wireless manner. In the wired communication, a power supply unit (not shown) provided within the casing 10 is used to provide the necessary power. In the wireless communication, the battery module 36 provided within the keyboard 30 is used to provide the necessary power of the emitter 34.

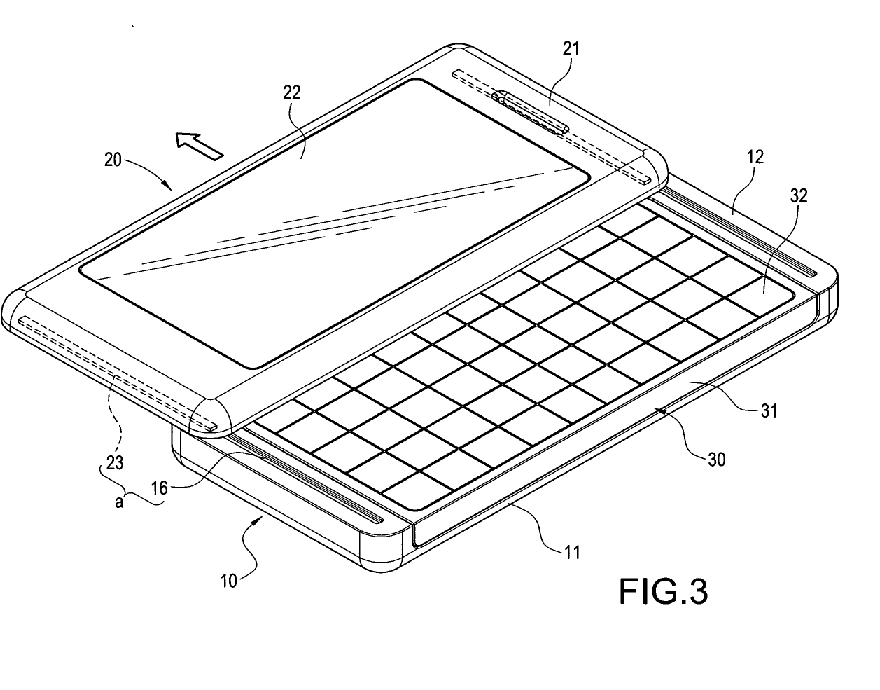

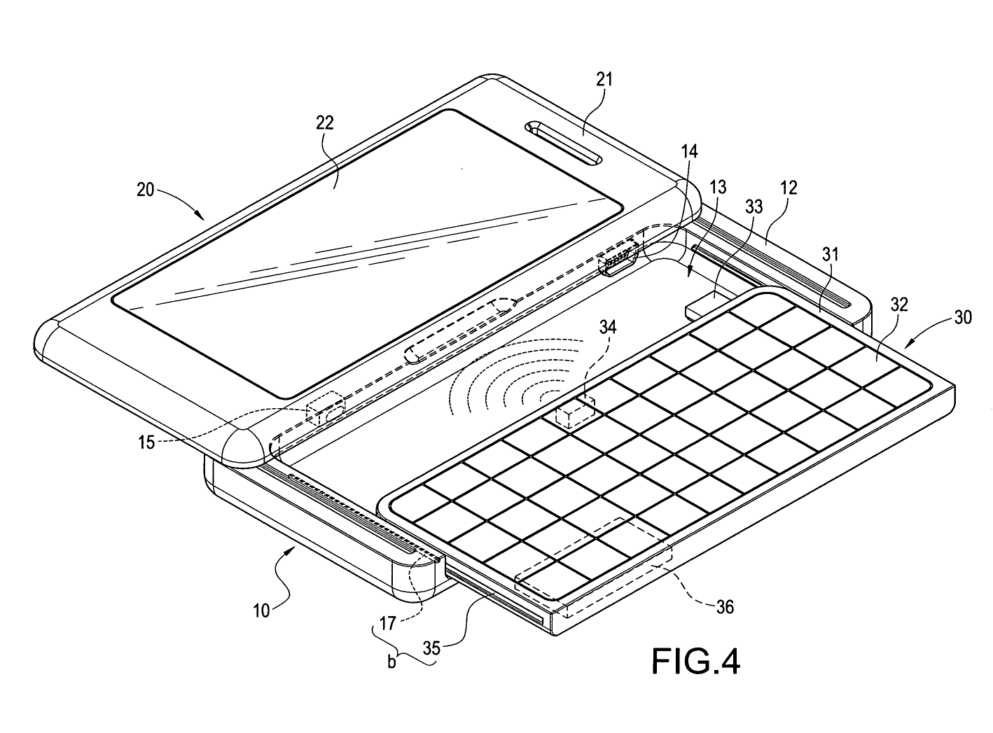

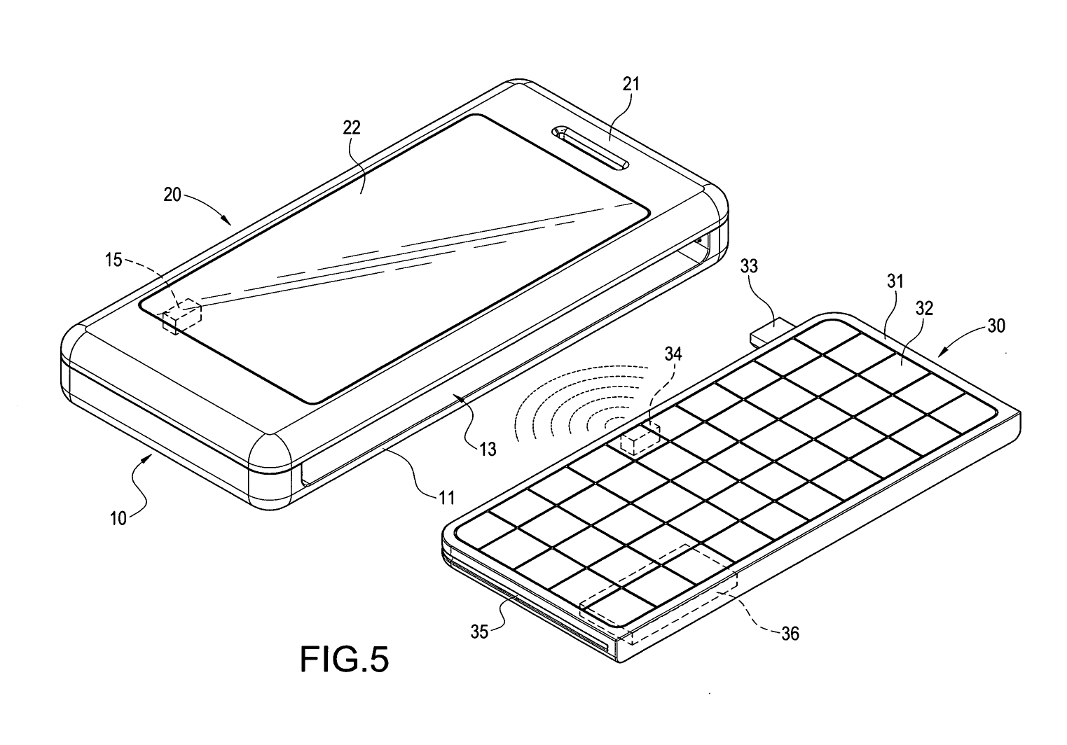

FIG. 3 is a schematic view showing the operating state of a wired communication of the present invention. FIG. 4 and FIG. 5 are schematic views (I) and (II) showing the operating state of a wireless communication of the present invention, respectively. As shown in FIG. 3, the display 20 is pushed toward the rear of the casing 10, so that the sliding rails 23 can slide with respect to the guiding troughs 16 of the surrounding plate 12. As a result, the keyboard 30 is exposed to the outside of the display 20, so that the user can perform a pressing operation to the press keys 32 of the keyboard 30 directly. At this time, the first and second connecting ports 14, 33 are connected to each other (i.e., in the wired communication). As shown in FIG. 4, the keyboard 30 displaces toward the front of the casing 10, so that the guiding rails 17 can slide with respect to the sliding troughs 35. At this time, the first and second connecting ports 14, 33 are disconnected. Via the switch controller (not shown) within the casing 10, the wired communication between the casing 10 and the keyboard 30 is stopped when the first and second connecting ports 14, 33 are disconnected. At this time the receiver 15 and the emitter 34 provided in the casing 10 and the keyboard 30 are activated simultaneously to perform the wireless communication. As shown in FIG. 5, the keyboard 30 is drawn out of the casing 10 completely and is disposed on the same plane as with the casing. Alternatively, the casing 10 and the display 20 can be arranged in an upright and raised manner (not shown). In this way, the communication device can be adjusted according to the demands of the user, thereby overcoming the uncomfortable feeling of the user generated in a long-time operation and improving the usability of the communication device.

According to the above, the handheld communication device having dual operating modes of the present invention really has industrial applicability, novelty and inventive steps. Further, the structure of the present invention has not been seen in the articles of the same kind or used in public, and thus conforms to the requirement for a utility model patent.

What is claimed is:

1. A handheld communication device having dual operating modes, comprising:
a casing formed with an accommodating trough, one side of the accommodating trough being provided with a first connecting port, the casing being connected thereon with a receiver;
a display sealed to cover on the accommodating trough and displaceable with respect to the casing; and
a keyboard detachably received in the accommodating trough, one side of the keyboard being provided with a second connecting port for insertion to correspond to the first connecting port, the keyboard being provided with an emitter for transmitting wireless signals to the receiver and a battery module for providing the necessary power of the emitter,
wherein wired and wireless operating modes are able to be switched via the mutual insertion and disconnection between the second connecting port and the first connecting port.

2. The handheld communication device having dual operating modes according to claim 1, wherein the wireless communication between the emitter and the receiver is achieved via infrared.

3. The handheld communication device having dual operating modes according to claim 1, wherein the wireless communication between the emitter and the receiver is achieved via a bluetooth technology.

4. The handheld communication device having dual operating modes according to claim 1, wherein the casing comprises a base and a U-lettered surrounding plate extending from the periphery of the base, and the accommodating trough is formed in the interior of the base and the surrounding plate.

5. The handheld communication device having dual operating modes according to claim 4, wherein the first connecting port is fixedly connected on a closed end of the surrounding plate.

6. The handheld communication device having dual operating modes according to claim 1, wherein a first sliding means is provided between the casing and the display.

7. The handheld communication device having dual operating modes according to claim 6, wherein the casing comprises a surrounding plate provided on the periphery of the accommodating trough, the display comprises a frame plate, the first sliding means is formed at the guiding troughs of the surrounding plate and the sliding rails of the frame plate, the sliding rails and the guiding troughs are slidably mated with each other.

8. The handheld communication device having dual operating modes according to claim 1, wherein a second sliding means is provided between the casing and the keyboard.

9. The handheld communication device having dual operating modes according to claim 8, wherein the casing comprises a surrounding plate provided on the periphery of the accommodating trough, the keyboard comprises a base plate, the second sliding means is formed at the guiding rails of the surrounding plate and the sliding troughs of the base plate, the sliding troughs and the guiding rails are slidably mated with each other.
